(19) United States
(12) Patent Application Publication
(10) Pub. No.: US 2011/0216525 A1
(43) Pub. Date: Sep. 8, 2011

(54) ENHANCED BEER TAP HANDLE

(76) Inventor: Tareef Talala, Rancho Mirage, CA (US)

(21) Appl. No.: 12/716,794

(22) Filed: Mar. 3, 2010

(51) Int. Cl. F21V 33/00

(52) U.S. Cl. 362/96

(57) ABSTRACT

In varying embodiments, an enhanced beer tap handle is disclosed whereby an illumination mechanism is coupled to an existing beer tap handle in order draw attention to the beer tap handle. Consequently, a competitive advantage is achieved by the beer manufacturer employing the enhanced beer tap handle relative to a non-illuminated beer tap handle. An aspect of the invention is an enhanced beer tap handle. The beer tap handle comprises a beer tap comprising a clamping nut and a stud and an illumination mechanism coupled on top of the clamping nut via the stud for illuminating the beer tap during operation.

### FIELD OF THE INVENTION

This invention relates generally to illuminated devices used for the purpose of promoting or calling attention to a particular brand of beer or other liquid product which is dispensed through a tap and sold where the invention is used, and more particularly to the handles that attach to the devices that dispense the product. While the invention is described with particular reference to liquid tap applications, those skilled in the art will recognize the wider application of the inventive principles described below.

### BACKGROUND OF THE INVENTION

Presently in establishments where chilled drinks such as tap beer, or the like, are served this is typically achieved by having a pressurized barrel containing the drink to be dispensed. The barrel is then connected via a keg connector and beer line, to a tap, such that when the tap is opened, the pressure of the beer inside the barrel results in the beer being dispensed into a glass. In order to maintain the pressure of the drink inside the barrel, the keg connectors include a gas pressure line through which gas is forced into the keg, thereby pressurizing the keg to urge liquid through the keg connector and subsequently into the dispensing line. In addition to this, a cooling system is usually used to cool the beer as it flows along the beer line, thereby ensuring that the drink is served at a desired chilled temperature.

Beer tap handles, which are decorated and identified with a particular beer brand, often are used in conjunction with the tap in establishments having low light conditions. Generally, the handles of one brand are adjacent to handles of competitive brands. Conventional handles are usually made of wood, ceramic, metal and plastic with metal accessories and decorated with static patterns, labels, colored drawings/paintings, laser decorations and so on. The handles attract users through complex shape or labels/decals in different kinds of materials to achieve competition in the market. However, only changes in shape and patterns of the handles cannot bring more attraction to the users and achieve better propaganda effects. An illuminated tap handle is more noticeable and easily associated with the brand of beer it represents, thereby giving a competitive advantage to that brand. Consequently, what is needed is a simple and cost effective way to illuminate the beer tap handle. The present invention addresses this need.

### SUMMARY OF INVENTION

In varying embodiments, an enhanced beer tap handle is disclosed whereby an illumination mechanism is coupled to an existing beer tap handle in order draw attention to the beer tap handle. Consequently, a competitive advantage is achieved by the beer manufacturer employing the enhanced beer tap handle relative to a non-illuminated beer tap handle.

An aspect of the invention is an enhanced beer tap handle. The beer tap handle comprises a beer tap comprising a clamping nut and a stud and an illumination mechanism coupled on top of the clamping nut via the stud for illuminating the beer tap during operation.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 shows a beer tap handle in accordance with an embodiment of the present invention.

FIG. 2 shows an illumination mechanism in accordance with an embodiment of the present invention.

FIG. 3 is a perspective view of the lamp portion in accordance with an embodiment of the present invention.

FIG. 4 shows a cross-section of the illumination mechanism in accordance with an embodiment of the present invention.

### DETAILED DESCRIPTION OF THE PRESENT INVENTION

An enhanced beer tap handle is disclosed. The following description is presented to enable one of ordinary skill in the art to make and use the invention and is provided in the context of a patent application and its requirements. Various modifications to the embodiments and the generic principles and features described herein will be readily apparent to those skilled in the art. Thus, the present invention is not intended to be limited to the embodiment shown but is to be accorded the widest scope consistent with the principles and features described herein.

Keg couplers, or “taps,” are known in the art and have been used for hundreds of years. For example, modern beer kegs are constructed of pressure-resistant, rust-resistant material, such as steel, in the shape of a barrel. At the top of the keg, there is provide an integral tap assembly through which the kegs are filled at the brewery and through which the contents are later extracted by imbibers. Conventional tap assemblies atop kegs include a neck with a top flange and internally positioned mounting lugs extending from a bunghole having a plunger ball seated therein. The plunger ball is spring biased against the top of the keg. In conjunction with a gasket surrounding bung hole, the spring-biased plunger ball maintains a fluid tight seal to not only protect the contents of the keg from spillage, but more importantly, to keep the contents of the keg under pressure from the carbon dioxide dissolved in the beer, or other fluid, disposed in keg. In varying embodiments of the present invention, an enhanced beer tap handle is disclosed whereby an illumination mechanism is coupled to an existing beer tap handle in order draw attention to the beer tap handle. Consequently, a competitive advantage is achieved by the beer manufacturer employing the enhanced beer tap handle relative to a non-illuminated beer tap handle.

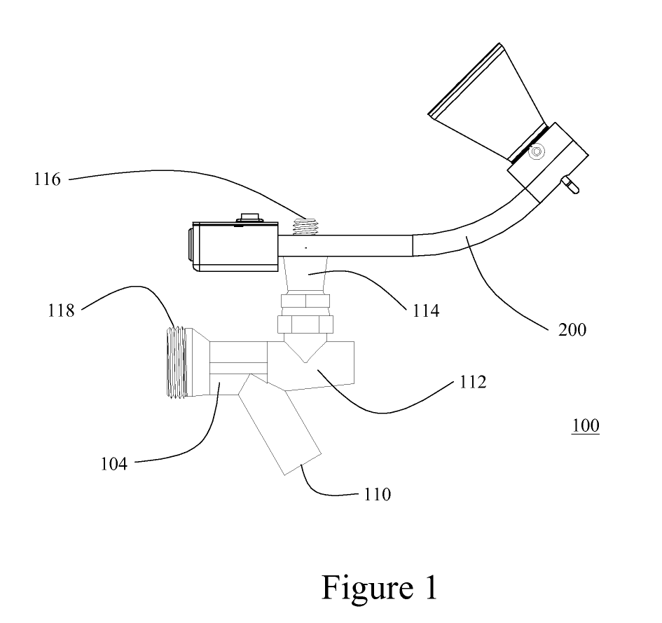

FIG. 1 shows a beer tap handle 100 in accordance with an embodiment of the present invention. The beer tap handle 100 includes a beer tap 104 and an illumination mechanism 200 coupled to the beer tap 104. The beer tap 104 comprises an outlet 110, a dispensing valve 112, a clamping nut 114 and a stud 116. Typically, a handle portion (not shown) is coupled to the beer tap 104 via the stud 116. The beer tap 104 is coupled to a beer keg (not shown) via the threaded portion 118.

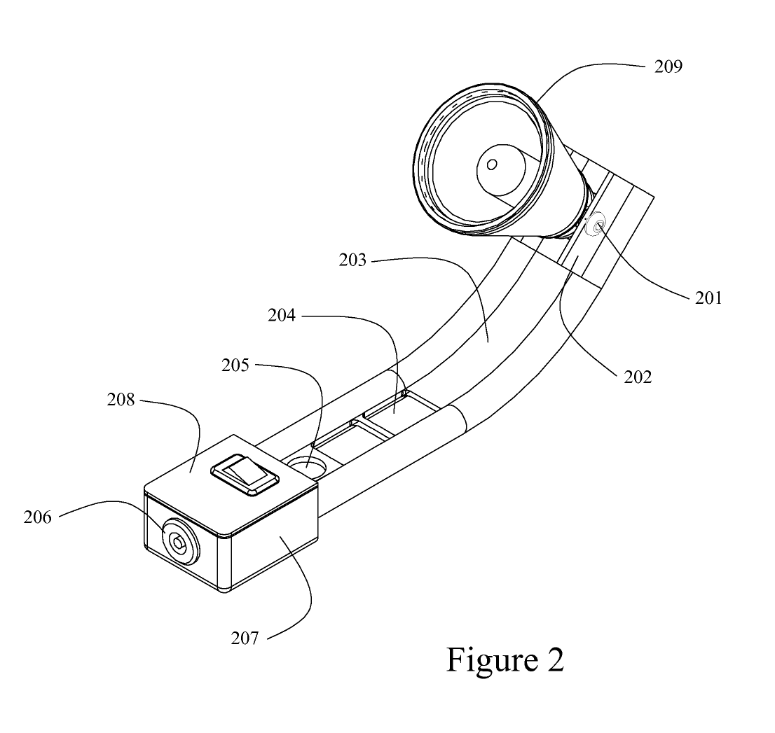

The illumination mechanism 200 is a separate piece that is coupled to the beer tap 104 on top of the clamping nut 114 via the stud 116. The handle portion is then coupled to the stud 116 thereby locking the illumination mechanism 200 into place. FIG. 2 shows the illumination mechanism 200 in accordance with an embodiment of the present invention. The mechanism 200 includes a pivot screw 201, a body flange 202, a flexible body portion 203, a drainage opening 204, a mounting hole 205, a power supply receptacle 206, an electrical cavity 207, a power switch 208 and a lamp portion 209. The mechanism 200 is coupled to the beer tap 104 in between the clamping nut 114 and the dispensing valve 112 via the mounting hole 205.

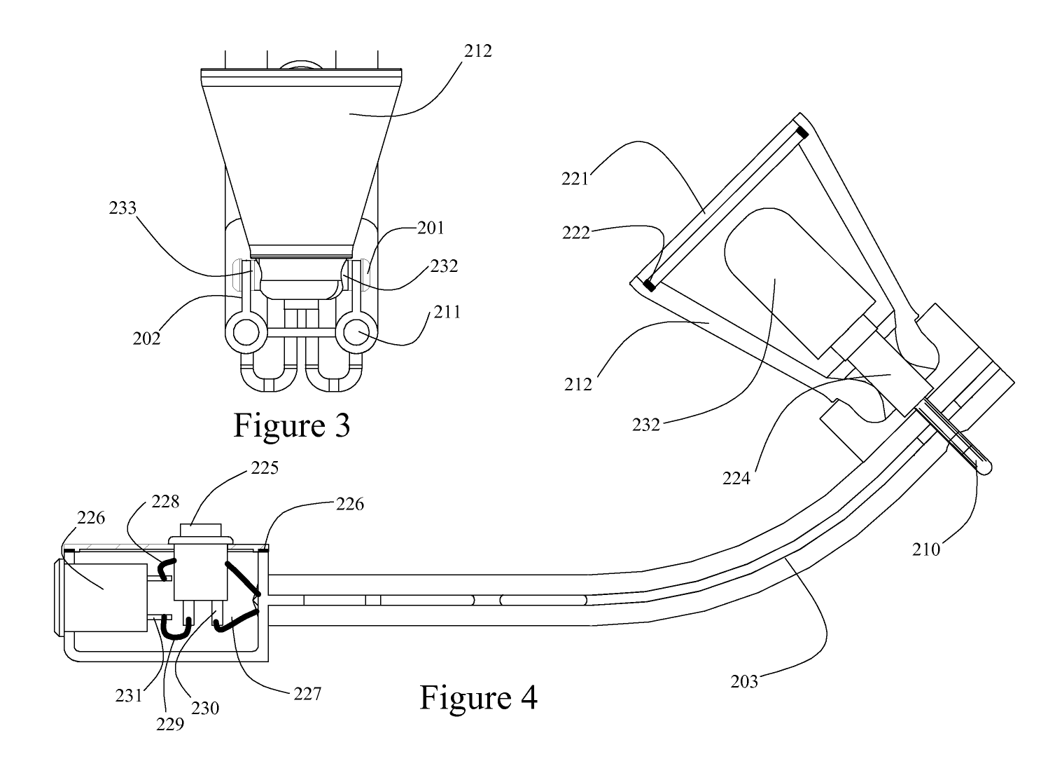

The lamp portion 209 houses the lamp and provides the lighting for the illumination mechanism 200. For a better understanding, FIG. 3 is a perspective view of the lamp portion 209 in accordance with an embodiment of the present invention. FIG. 3 shows the pivot screw 201 and the body flange 202 shown in FIG. 2. Also shown are wire leads 210, a wire way plug 211, a lamp shade 212, a pivot washer 232 and the pivot stub shaft 233. Accordingly, the lamp portion 209 is allowed to pivot to the desired position via the pivot stub shaft 233.

FIG. 4 shows a cross-section of the illumination mechanism 200 in accordance with an embodiment of the present invention. FIG. 4 shows the previously shown body portion 203, power supply receptacle 206, wire leads 210 and the lamp shade 212. Also, shown is the lamp lens 221, lens gasket 222, the lamp 223 and the lamp holder 224. The body portion 203 is coupled to an electrical portion 220. The electrical portion 220 includes the power switch 208, a cover gasket 226, switch wire lead 227, receptacle wire lead 228, jumper wire 229, switch connection 230 and receptacle connection 231.

Although the above described embodiment is described in the context of being utilized in conjunction with beer, one of ordinary skill in the art will readily recognize that a variety of different liquids could be employed while remaining within the spirit and scope of present invention.

During operation, the illumination mechanism 200 is configured to be coupled to a power source via the power supply receptacle 206 and manually switched on/off via the power switch 208, although a battery operated embodiment is not out of the realm of perception. It is anticipated that the illumination mechanism 200 will be turned on during business hours thereby highlighting the beer manufacturer's brand to the surrounding customers.

In varying embodiments, an enhanced beer tap handle is disclosed whereby an illumination mechanism is coupled to an existing beer tap handle in order draw attention to the beer tap handle. Consequently, a competitive advantage is achieved by the beer manufacturer employing the enhanced beer tap handle relative to a non-illuminated beer tap handle.

Without further analysis, the foregoing so fully reveals the gist of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although this invention has been described in terms of certain embodiments, other embodiments that are apparent to those of ordinary skill in the art are also within the scope of this invention, as defined in the claims that follow.

What is claimed is:

1. An enhanced beer tap handle comprising:
a beer tap comprising a clamping nut and a stud; and
an illumination mechanism coupled on top of the clamping nut via the stud for illuminating the beer tap during operation.

2. The beer tap handle of claim 1 wherein the illumination mechanism comprises a lamp fixture.

3. The beer tap handle of claim 2 wherein the lamp portion further comprises:
a lamp;
a lamp shade; and
a lamp holder.

4. The beer tap handle of claim 3 wherein the illumination mechanism includes a switch for selectively turning the lamp on and off.

5. The beer tap handle of claim 4 wherein the illumination mechanism further comprises a mounting hole and the illumination mechanism is coupled on top of the clamping nut via the mounting hole.

6. The beer tap handle of claim 5 wherein the illumination mechanism further comprises a flexible body portion coupled to the lamp portion.
